(19) United States
(12) Patent Application Publication
(10) Pub. No.: US 2014/0189135 A1
(43) Pub. Date: Jul. 3, 2014

(54) Methods, Systems, and Media for Secure Connection Management

(71) Applicant: Kent Lawson, Sherman, CT (US)

(72) Inventor: Kent Lawson, Sherman, CT (US)

(21) Appl. No.: 14/144,750

(22) Filed: Dec. 31, 2013

Related U.S. Application Data
(60) Provisional application No. 61/747,912, filed on Dec. 31, 2012.

(51) Int. Cl. H04L 29/08

(52) U.S. Cl. CPC H04L 67/141
USPC 709/227

(57) ABSTRACT

Methods, systems and media for secure connection management are provided. In some embodiments, methods for secure connection management are provided, the methods comprising: detecting, using a hardware processor, a new network connection; determining that the new network connection is not a secure connection; establishing a virtual private network connection in response to determining that the new network connection is not secure; and upon establishing the virtual private network connection, indicating to a user that the virtual private connection is established.

### CROSS-REFERENCE TO RELATED APPLICATIONS

This application claims the benefit of U.S. Provisional Patent Application No. 61/747,912, filed Dec. 31, 2012, which is hereby incorporated by reference herein in its entirety.

### TECHNICAL FIELD

The disclosed subject matter relates to methods, systems, and media for secure connection management.

### BACKGROUND

Wireless network connections (e.g., Wi-Fi) are increasingly being used to connect devices (e.g., laptop computers, tablet computers, etc.) to networks, such as, the Internet. Unsecured wireless networks (e.g., a network that is not password protected using, for example, wireless protected access) present security and privacy risks to users of devices connected to such networks. Connecting to an unsecured network, such as a public Wi-Fi hotspot, can allow malicious users to gain access to unencrypted communications through sniffers, sidejacking, honeypot attacks, Address Resolution Protocol (ARP) spoofing, etc. Technologies exist for securing communications over an unsecured network, but the technologies rely on the user to determine the security of a network and connect to a service, such as a VPN, manually each time they connect through an unsecured network. Many users do not expend the effort to do this, or lack the technical know-how to secure their communications.

Therefore there is a need for approaches for automatically detecting the security of a network that a device is connected to and controlling that device's connection to the network based on the detected security. Accordingly, it is desirable to provide methods, systems, and media for secure connection management.

### SUMMARY

In accordance with various embodiments of the disclosed subject matter, methods, systems, and media for secure connection management are provided.

In accordance with some embodiments of the disclosed subject matter, methods for secure connection management are provided, the methods comprising: detecting, using a hardware processor, a new network connection; determining that the new network connection is not a secure connection; establishing a virtual private network connection in response to determining that the new network connection is not secure; and upon establishing the virtual private network connection, indicating to a user that the virtual private connection is established.

In some embodiments, determining that the network connection is not a secure connection comprises determining that the network connection includes an unencrypted wireless network connection.

In some embodiments, establishing a virtual private network connection comprises: determining a server to which the virtual private network connection is to be made; initiating a virtual private network connection to the server; causing a first colored indicator to be presented to the user in response to the initiating, wherein the first color indicates that a connection to the virtual private network connection is initiated; and wherein indicating to a user that the virtual private connection is established comprises causing a second colored indicator to be presented to the user.

In some embodiments, determining the server comprises: determining a location of a device including the hardware processor; selecting a plurality of servers including the server based on the location of the device; receiving information identifying one server of the plurality of servers as a server having a lowest workload; and selecting the one server from a plurality of servers as the server to which the virtual private network connection is to be made.

In some embodiments, the methods further comprise: determining that the new network connection is a secure connection; and causing a third colored indicator to be presented to the user upon determining that the new network connection is a secure connection.

In some embodiments, the methods further comprise determining that the connection to the virtual private network cannot be established; and causing a fourth colored indicator to be presented to the user upon determining that the virtual private network connection cannot be established, wherein the fourth color indicates that a connection to the virtual private network cannot be established.

In some embodiments, the first color is yellow, the second color is green, the third color is blue and the fourth color is red.

In some embodiments, the indicator is at least one of an icon displayed by a display coupled to the hardware processor, and an indicator light coupled to the hardware processor.

In some embodiments, the methods further comprise: determining that the connection to the virtual private network cannot be established using a first port; automatically choosing a second port of the server to use in establishing the virtual private network connection; and initiating the virtual private network connection to the server using the second port.

In accordance with some embodiments, system for secure connection management are provided, the systems comprising: a hardware processor programmed to: detect a new network connection; determine that the new network connection is not a secure connection; establish a virtual private network connection in response to determining that the new network connection is not secure; and upon establishing the virtual private network connection, indicate to a user that the virtual private connection is established.

In accordance with some embodiments, non-transitory computer-readable media containing computer executable instructions that, when executed by a processor, cause the processor to perform a method for secure connection management are provided, the method comprising: detecting a new network connection; determining that the new network connection is not a secure connection; establishing a virtual private network connection in response to determining that the new network connection is not secure; and upon establishing the virtual private network connection, indicating to a user that the virtual private connection is established.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of a process for secure connection management in accordance with some embodiments of the disclosed subject matter.

FIG. 2 shows an example of a process for determining a server to use for a virtual private network connection in accordance with some embodiments of the disclosed subject matter.

FIG. 3 shows an example of a process for determining a virtual private network technology to be used in accordance with some embodiments of the disclosed subject matter.

FIG. 4 shows an example of a schematic diagram of a system suitable for implementation of mechanisms described herein for secure connection management in accordance with some embodiments of the disclosed subject matter.

FIG. 5 shows an example of a user device and virtual private network server of FIG. 4 that can be used in accordance with some embodiments of the disclosed subject matter.

### DETAILED DESCRIPTION

In accordance with various embodiments, mechanisms for secure connection management are provided. These mechanisms can include automatically determining whether a device's connection to a network is secure and connecting the device to the network through a virtual private network when the connection is determined to not be a secure connection. Using these mechanisms for automatically connecting to the network securely, a user's privacy and device security can be protected.

These mechanisms can be used in a variety of applications. For example, these mechanisms can be used to ensure that a device is automatically connected to a network securely, without requiring a user of the device to be aware of the security of various network connections. In a more particular example, a device, such as a laptop computer, can be connected to the Internet securely on an unprotected public Wi-Fi hotspot by the mechanisms determined that the public Wi-Fi connection is not secure.

In some embodiments, a VPN server that a device is connected to can act as a proxy server, where all traffic to and from the device can be encrypted and routed through the VPN server. Additionally or alternatively, the device can appear to be assigned a new Internet Protocol address (IP address) when the device makes a VPN connection. This can allow for a device user's privacy to be further protected by changing the IP address of the device.

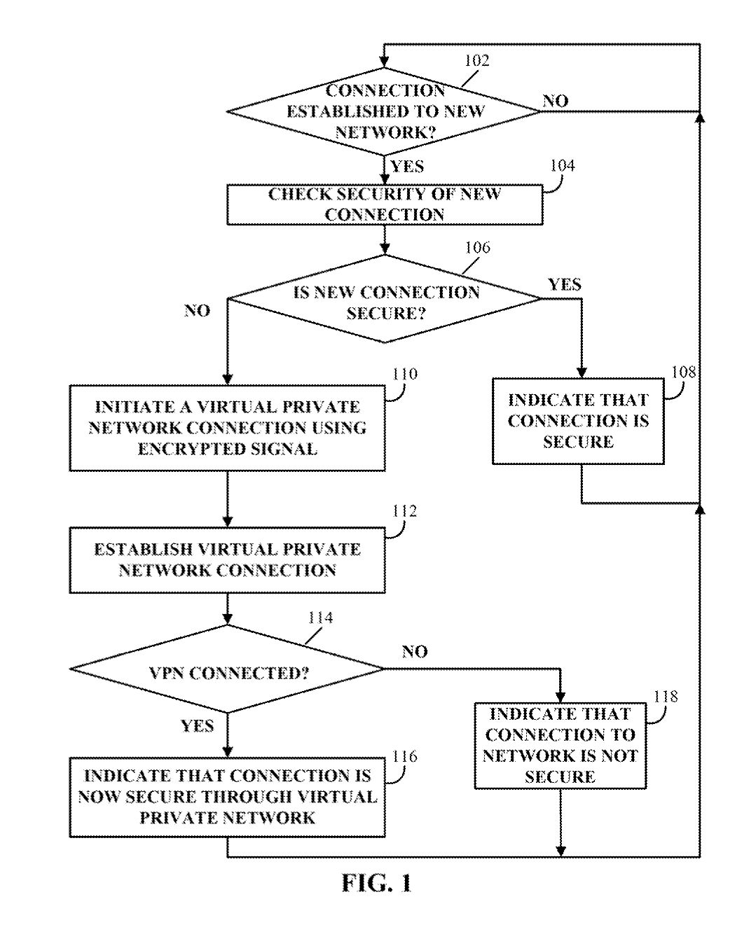

Turning to FIG. 1, an example 100 of a process for secure connection management is shown in accordance with some embodiments of the disclosed subject matter. In some embodiments, process 100 can be initiated in response to a user device being powered on and can run on the user device to determine if a new network connection has been established and whether that new network connection is a secure connection. For example, a laptop computer can initiate process 100 when the computer is powered on and can run process 100 in the background. As another example, process 100 can be initiated in response to a user selecting to initiate process 100. In a more particular example, process 100 can be included as part of an application installed on the user device, and the user can start the application to initiate process 100. As another example, process 100 can be initiated based on settings of a user device that executes process 100. In a more particular example, process 100 can be initiated when a network connection is enabled on the user device that executes process 100 (e.g., when a Wi-Fi connection is enables). In another more particular example, process 100 can be initiated when the user device enters and/or exits a particular location (e.g., when the user device exits an area designated as a user's home, work, etc.).

At 102, process 100 can determine if a new network connection has been made by the device executing process 100. In some embodiments, process 100 can intercept an instruction to establish a new network connection. For example, if a laptop computer is powered on and attempts to make a connection to a wireless network (e.g., a network complying with any of the IEEE 802.11 standards for wireless networking, commonly referred to as Wi-Fi), process 100 can determine that a new network connection is being established. In such an example, if the user then connects to the same network by Ethernet cable, process 100 can determine that this is also a new connection. As another example, if a smartphone enters a range of a public Wi-Fi hotspot and the smartphone attempts to automatically connect to the Wi-Fi hotspot, process 100 can determine that this is a new network connection. As still another example, process 100 can check a status of a network connection (e.g., by determining whether an IP address of a network connection has been configured or changed) to determine if the a network connection has changed since a last check was made.

If a new network connection is not detected (“NO” at 102), process 100 can return to 102 to wait for a new network connection. Otherwise, if a new network connection is detected (“YES” at 102), process 100 can move to 104 to determine if the new connection is a secure connection.

At 104, process 100 can determine if the new network connection detected at 102 is a secure connection. In some embodiments, certain classes of connection can be considered secure, while other classes of connection can be considered not secure. For example, dial-up connections, Ethernet connections, and certain encrypted wireless connections (e.g., wireless networks using Wi-Fi Protected Access (WPA) and Wi-Fi Protected Access II (WPA2)) can be considered secure connections. As another example, public wireless networks (e.g., a Public Wi-Fi Hotspot), and certain other encrypted wireless connections (e.g., wireless networks secured using Wired Equivalent Protection (WEP)) can be considered not secure. Additionally, process 100 can periodically receive updated information as new technologies are developed and/or as existing technologies become compromised, identifying types of networks and/or security protocols that are considered secure and/or identifying types of networks and/or security protocols that are considered non-secure. For example, process 100 can receive information indicating that certain types of connections are no longer recognized as secure connections, while new connection types can be added as connections that are now considered secure connections. Any suitable technique can be used to update process 100, such as updating an application that runs process 100, patching an application that runs process 100, receiving updated information in response to a query initiated by process 100, and/or any other suitable techniques.

Additionally or alternatively, in some embodiments, process 100 can evaluate security credentials (e.g., a password, pass phrase, pass code, etc.) used to access a secure network to determine security of the network connection. For example, a password can be evaluated to determine a strength of the password. In such an example, if process 100 determines that the password is weak (e.g., easy to guess or known to be compromised in some way), process 100 can consider the new connection to be a non-secure connection. In some embodiments, process 100 can cause a message to be presented to the user urging the user to adopt a stronger password, and/or process 100 can use any other suitable technique to inform the user of why the secure network connection is considered non-secure.

If the new connection is a secure connection (“YES” at 106), process 100 can move to 108 and indicate that the new connection is a secure connection. Otherwise, if the new connection is not a secure connection (“NO” at 106), process 100 can move to 110 where a connection to a virtual private network can be initiated using an encrypted signal.

At 108, process 100 can indicate that the new connection is a secure connection. For example, process 100 can cause a color of an icon (e.g., an icon in a taskbar, system tray, menu bar, etc.) to be changed to indicate that the connection is secure. As another example, process 100 can cause a color of an indicator light (e.g., an LED) to be changed to indicate that the connection is secure. More particularly, in either of the preceding examples, process 100 can cause the color of the icon or indicator light to be made blue to indicate that the connection is a secure connection. As yet another example, process 100 can cause a window to be displayed to a user indicating that the connection is secure. After indicating that the new connection is secure at 108, process 100 can return to 102 to determine if a new network connection is established.

At 110, if the new network connection is determined to not be secure at 104 and 106, process 100 can cause a secure connection to be initiated using an encrypted signal. In some embodiments, process 100 can initiate encrypted communications when it is determined that the network connection is not secure to protect any outgoing communications from a user device executing process 100 that may be intercepted on the non-secure network.

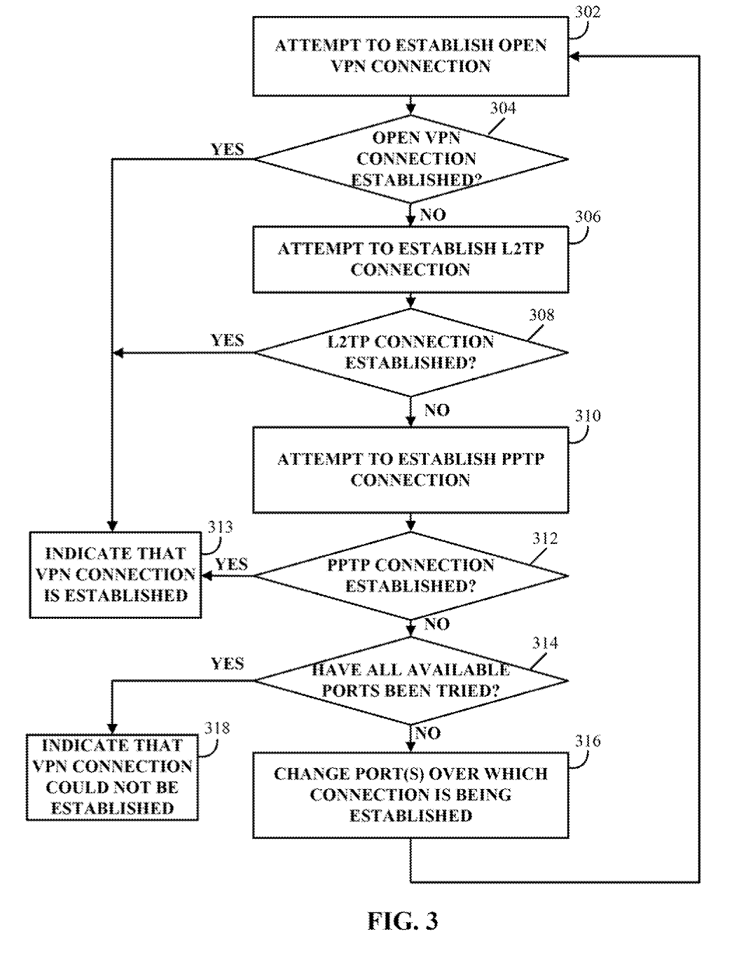

In some embodiments, process 100 can initiate a virtual private network (VPN) session at 110. For example, process 100 can cause a session between the user device and a server (also referred to herein as a VPN server or a proxy server) to be initiated using an encrypted signal in an effort to protect the communications between the user device and the server. Any suitable VPN technology can be used to establish the secure session using any suitable connection. For example, Open VPN, Layer 2 Tunneling Protocol (LT2P) or Point-to-Point Tunneling Protocol (PPTP), Internet Protocol Security (IPSec), or any other suitable VPN technology can be used to establish a VPN session between the device and the server. As described below in connection with FIG. 3, various VPN technologies can be used to attempt to establish a VPN connection and/or session if a connection cannot initially be established.

In some embodiments, a connection to the VPN can be established using a user name and password (or pass phrase, pass code, etc.). Additionally or alternatively, a token can be used in establishing a connection to the VPN. For example, a user can be assigned a token generator that generates an authentication code to be entered by the user (e.g., SecurID). As another example, a user can have a mobile device that can communicate using near-field communication (NFC) with the user device to authenticate the presence of the user at the device connecting the network. As yet another example, a user can be associated with hardware (e.g., a USB dongle) that can authenticate that the user of the user device is an authorized user. In some embodiments, any suitable combination of these and/or any other suitable security measures and/or techniques can be used in establishing and/or maintaining a connection to the VPN.

In some embodiments, multiple VPN servers at one or more geographic locations can be made available to establish a virtual private network connection. For example, in some embodiments, servers used by the mechanisms described herein to establish a virtual private network connection can be organized into clusters at various geographic locations. In general, if other factors are held constant (e.g., workload, hardware, etc.), a virtual private network connection to a server that is geographically closer provides a faster connection when acting as a proxy server (e.g., retrieving data from the Internet is faster through a VPN to a geographically closer server). Process 100 can determine which server to connect to based on the geographic location and/or the workload of each server. For example, process 100 can determine a VPN server and/or cluster of VPN servers that is located nearest geographically to a device executing process 100. In a more particular example, process 100 can query a server that includes a list of VPN server and/or cluster locations for information on the geographic locations of various VPN servers that can be used to establish a VPN connection. The list can be administered, for example, as part of a system for establishing VPN connections and can be updated manually and/or automatically. In such an example, the device executing process 100 can query the server for the entire list or can include information about the current geographic location of the device and receive a subset of VPN servers and/or clusters that are located closest to the device in response to the query. Any suitable information about the current geographic information of the device can be used to determine a geographically nearest server and/or cluster, such as IP address of the device, location information based on GPS, network-based location information (e.g., location based on triangulation to cellular towers), and/or any other suitable location information. In some embodiments, process 100 can determine which VPN server to connect to based on a network distance to various VPN servers. For example, a distance between the device executing process 100 and each VPN server and/or cluster of servers in a routing map of a network to which both devices are connected (e.g., the Internet). In a more particular example, the network distance can be proportional to a number of nodes of the network a packet must traverse to reach the VPN server from the device executing process 100. Additionally or alternatively, process 100 can initiate a connection to a default address and can be automatically redirected to a nearest VPN server based on geographic information about the device.

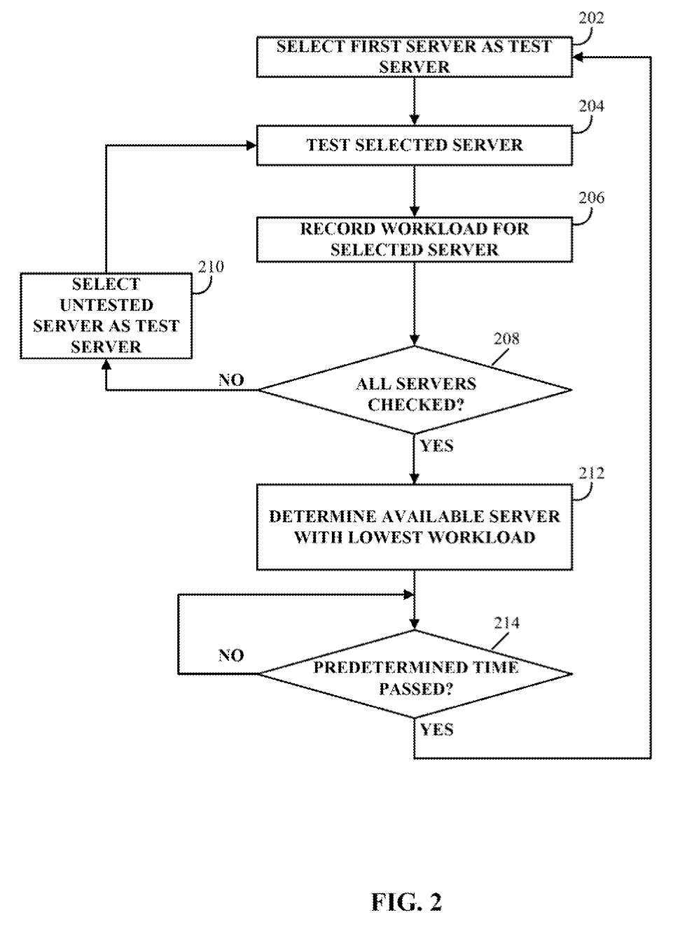

In some embodiments, in addition to or in lieu of using geographic distance, any suitable load balancing techniques can be used to determine a server to connect to among multiple servers. For example, Round-robin DNS techniques can be used to determine which server to make a new connection to. As another example, the load of one or more processors in each available server can be monitored, and the result of such monitoring can be used to determine which server to make a new connection to based on the monitored load. As yet another example, as described below in connection with FIG. 2, the workload of each server that can be used with the mechanisms described herein can be monitored and a server that is determined to provide a best connection can be chosen as a server to connect to. As still another example, information about each server, such as a number of current connections, available memory, available processor capacity, and/or any other parameters that can be used to characterize workload, can be used to determine a server to connect to.

At 114, process 100 can determine if a VPN connection has been established. If a VPN connection has been established (“YES” at 114), process 100 can indicate that the new connection is now secure based on the VPN connection being established at 116. For example, process 100 can cause a color of an icon (e.g., an icon in a taskbar, system tray, menu bar, etc.) to be changed to indicate that the connection is secure. As another example, process 100 can cause a color of an indicator light (e.g., an LED) to be changed to indicate that the connection is secure. More particularly, in either of the preceding examples, the color of the icon or indicator light can be made green to indicate that the connection has been made secure by a connection over a VPN. As yet another example, process 100 can cause a window to be displayed to a user indicating that the connection is now secure by a connection over a VPN. After indicating that the new connection is now secure at 116, process 100 can return to 102 to determine if a new network connection is established.

On the other hand, if it is determined that a connection to a VPN cannot be established (“NO” at 114), process 100 can indicate that the connection is not secure at 118. For example, process 100 can cause a color of an icon (e.g., an icon in a taskbar, system tray, menu bar, etc.) to be changed to indicate that the connection is not secure. As another example, process 100 can cause a color of an indicator light (e.g., an LED) to be changed to indicate that the connection is not secure. More particularly, in either of the preceding examples, the color of the icon or indicator light can be made red to indicate that the connection has not been made secure by a connection via a VPN. As yet another example, process 100 can cause a window to be displayed to a user indicating that the connection is not secure. After indicating that the new connection is not secure at 118, process 100 can return to 102 to determine if a new network connection is established. In some embodiments, if the network connection is not secure and a connection to a VPN cannot be established, process 100 can inhibit the device from making further connections to the network as long as the connection is not secure and/or if a VPN connection cannot be established. For example, if the network is not secure (e.g., a connection to the network is through an unsecured public Wi-Fi Hotspot) and a connection to a VPN cannot be established for any reason (e.g., because a firewall at some point in the network is preventing a connection to any VPN), then the device can be prevented from connecting to the network through the non-secure connection. In some cases, a user of the device can control a setting associated with process 100 to allow non-secure connections to be made by the device. For example, process 100 can receive an instruction indicating that the user is overriding process 100, and in response process 100 can allow one or more connections to be made that are not secure.

In some embodiments, when the device is launching the mechanisms described herein (or when a connection to a VPN server is being established) process 100 can cause a color of an icon or indicator light to be yellow to indicate that a connection may not be secure. Although particular colors are described as corresponding to a security of a network, these are merely given as examples and any suitable colors and/or other indicators (such as text) can be used to indicate a security status of a network connection to the user.

Turning to FIG. 2, an example of a process 200 for determining a server to use for a virtual private network connection is shown in accordance with some embodiments of the disclosed subject matter. In some embodiments, as described above in connection with 110 of FIG. 1, servers used by the mechanisms described herein to establish a virtual private network connection can be organized into clusters at various geographic locations. For each cluster, a monitoring server can check a workload at each server in the cluster periodically. For example, the monitoring server can access each server and simulate an intensive user session, which can include sending and retrieving significant data through the server. The amount of time it takes to complete the simulated session can be recorded and used as one factor in determining a workload of each server. For instance, a time to complete a user session based on any suitably sized file, such as a fifteen megabyte file, can be used as one factor in determining a workload of each server.

Process 200 can begin by selecting a first server in a cluster at 202. At 204, process 200 can test the server to determine the server's workload. For example, process 200 can test the server using a simulated user session as described above.

At 206, process 200 can cause the workload for the selected server to be recorded. For example, a table of workload values for each server at the cluster can be maintained and periodically updated.

At 208, process 200 can determine if an updated workload value has been calculated for each available server. For example, if a server is offline for maintenance, process 200 can proceed without checking that server's workload. If not all servers in the cluster have been checked (“NO” at 208), process 200 can move to 210 and select a server in the cluster that has not been tested, and process 200 can return to 204 to test the newly selected server. In some embodiments, all servers in a particular cluster can be tested in parallel (e.g., simultaneously), or groups of servers in a cluster can be tested in parallel.

If all servers have been checked (“YES” at 208), process 200 can move to 212 where a server with a lowest workload can be determined. In some embodiments, process 200 can identify a particular server having a lowest workload in a cluster as a preferred server in the cluster. Additionally or alternatively, at 212, process 200 can make information about the workload of each server in the cluster available to be used in determining which server to make a virtual private network connection to by a device utilizing the mechanisms described herein (e.g., by a user device executing process 100).

At 214, process 200 can determine if a predetermined time has passed since the servers in the cluster were last checked, and if the predetermined amount of time has passed (“YES” at 214), process 200 can return to 202 and begin testing the servers in the cluster again. Otherwise, if the predetermined amount of time has not passed (“NO” at 214), process 200 can return to 214 to determine if the predetermined period of time has passed. For example, after the servers in a cluster are checked, the monitoring server can wait five minutes (or any other suitable period of time) and then begin checking the servers in the cluster again. In some embodiments, the predetermined period of time can be variable and can be based on the current number of connections and/or the number of new connections being made. For example, if there are currently a large number of VPN connections open to the server (e.g., if utilization is over 50%, 60%, etc.), the predetermined amount of time can be decreased, such that workload is more closely monitored. Additionally or alternatively, regardless of whether the predetermined amount of time has passed, if a specified number of new connections is made, process 200 can cause the monitoring server to check the workload of the servers to update the workload information. Process 200 can then make the information on the workload of the servers available to a device attempting to establish a connection to a server in cases when a large number of devices establish a VPN connection to the same server in the time between workload scheduled updates.

Process 200 can be used, for example, in choosing a server to contact to establish a VPN connection at 110 in process 100. As another example, process 200 can provide information about server workload for any process used to determine a server to which a VPN connection is to be made (e.g., a process other than process 100).

FIG. 3 shows an example 300 of a process for determining a VPN technology to use in establishing a VPN connection to a server in accordance with some embodiments of the disclosed subject matter. At 302, process 300 can cause an attempt to be made to establish a connection to a VPN server using an application based on OpenVPN. This attempt can be made using any suitable port, for example, port 1194 can be used to attempt to establish a connection using OpenVPN. At 304, process 300 can determine whether an OpenVPN connection is established. If an OpenVPN connection is established (“YES” at 304), process 300 can move to 313 and indicate that a VPN connection is established. Otherwise, if an OpenVPN connection is not established (“NO” at 304), process 300 can move to 306.

At 306, process 300 can cause an attempt to be made to establish a connection to a VPN server using an application based on L2TP. This attempt can be made using any suitable port, for example, port 1701 can be used to attempt to establish a connection using L2TP. At 308, process 300 can determine whether an L2TP connection is established. If an L2TP connection is established (“YES” at 308), process 300 can move to 313 and indicate that a VPN connection is established. Otherwise, if an L2TP connection is not established (“NO” at 308), process 300 can move to 310.

At 310, process 300 can cause an attempt to be made to establish a connection to a VPN server using an application based on PPTP. This attempt can be made using any suitable port, for example, port 1723 can be used to attempt to establish a connection using PPTP. At 312, process 300 can determine whether a PPTP connection is established. If a PPTP connection is established (“YES” at 312), process 300 can move to 313 and indicate that a VPN connection is established. Otherwise, if a PPTP connection is not established (“NO” at 312), process 300 can move to 314.

At 314, process 300 can determine if all available ports have been tried for each of the various VPN technologies used by the mechanisms described herein. If all available ports have been tried (“YES” at 314), process 300 can either move to 318 and indicate that a VPN was not successfully established, or try available ports again (not shown). Otherwise, if not all available ports have been tried, process 300 can cause the ports over which a connection is initiated to be changed to an alternate port (or ports) at 316. For example, each VPN server can use alternate ports through which a VPN connection can be established for each technology. In a more particular example, if an Open VPN connection is not successfully established using port 1194, an OpenVPN connection can be initiated using any other suitable port, such as port 443. This can be repeated for each alternate port available for each VPN technology. Although OpenVPN, L2TP and PPTP are described herein, any suitable technology for establishing a secure and/or encrypted encrypted connection to the Internet (or any other suitable network) can be used. For example, IPSec can be used to establish a secure connection when connected on an unsecured wireless connection. As another example, SSL can be used to establish a secure connection when connected on an unsecured wireless connection.

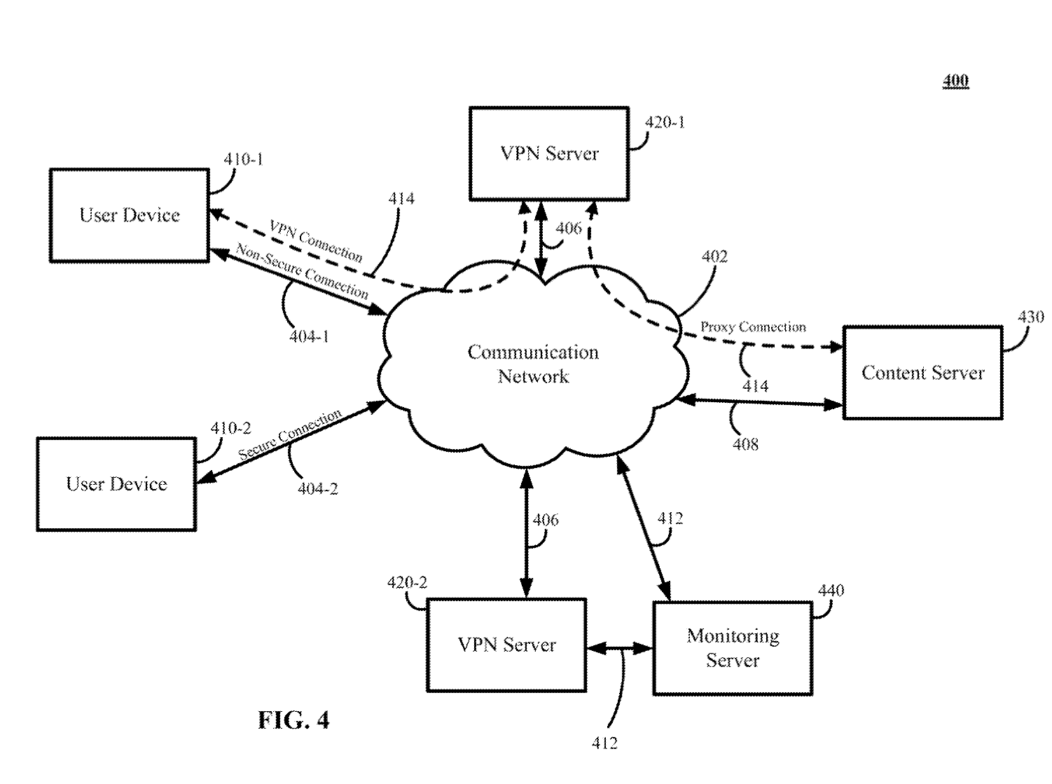

FIG. 4 shows an example of 400 of a generalized schematic diagram of a system on which the mechanisms for secure connection management as described herein can be implemented in accordance with some embodiments. As illustrated, system 400 can include one or more user devices 410. User devices 410 can be local to each other or remote from each other. User devices 410 can be connected by one or more communications links 404 to a communications network 402 that can be linked via a communications link 406 to one or more VPN servers 420, one or more content servers 430 via a communications link 408, and/or one or more monitoring servers 440 via a communications link 412.

In some embodiments, each of user devices 410, VPN server 420, content server 430 and monitoring server 440 can be any of a general purpose device such as a computer or a special purpose device such as a client, a server, etc. Any of these general or special purpose devices can include any suitable components such as a hardware processor (which can be a microprocessor, digital signal processor, a controller, etc.), memory, communication interfaces, display controllers, input devices, etc. For example, user device 410 can be implemented as a personal computer, a laptop computer, a smartphone or other cellular telephone, a tablet computer, a wearable computer, a personal digital assistant, a portable music player, a portable video player, a handheld game console, a set-top box, a game console, a digital media receiver, a server computer, a router, and/or any other suitable computing device. As another example, VPN server 420 can be implemented as a server computer, a personal computer, a laptop computer, a router, a smartphone or other cellular telephone, a tablet computer, a wearable computer, a personal digital assistant, a portable music player, a portable video player, a handheld game console, a set-top box, a game console, a digital media receiver, a server computer, and/or any other suitable computing device. Content server 430 and monitoring server 440 can be implemented using any suitable computing device, such as computing devices described in connection with VPN server 420.

Communications network 402 can be any suitable computer network or combination of such networks including the Internet, an intranet, a wide-area network (WAN), a local-area network (LAN), a wireless network, a digital subscriber line (DSL) network, a frame relay network, an asynchronous transfer mode (ATM) network, a virtual private network (VPN), etc. Communications links 404, 406, 408, and 412 can be any communications links suitable for communicating data among user devices 410, VPN servers 420, content servers 430 and monitoring server 440, such as network links, dial-up links, wireless links, hard-wired links, optical links, infrared links, any other suitable communications links, or any suitable combination of such links.

In some embodiments, system 400 can include one or more user devices 410 (e.g., 410-1 and 410-2) that can: execute processes associated with the mechanisms described herein (such as process 100 and/or process 300); establish a VPN connection with a VPN server such as VPN server 420; request content from a content server such as content server 430; request a status of various VPN servers to which a VPN connection can be established from a monitoring server such as monitoring server 430; and/or perform any other suitable actions.

In some embodiments, system 400 can include one or more VPN servers 420 that can: receive a request to establish a VPN connection from a user device, such as user device 410; receive a request from a user device to send and/or request data from a remote device such as content server 430; send and/or request data from content server 430 in response from the request received from the user device; send and/or request data from the user device in response to data received from content server 430; decrypt data received over a VPN connection from a user device; encrypt data to be sent to the user device; and/or perform any other suitable actions.

In some embodiments, system 400 can include one or more content servers 430 that can: receive request for content from a device such as user device 410, VPN server 420 and/or any other suitable device; send data in response to a request for content; and/or perform any other suitable actions. In some embodiments, content server 430 can be a web content server that hosts web pages, a music hosting server that hosts music files, an image hosting server that hosts image files, and/or any other suitable server for storing any other suitable content.

In some embodiments, system 400 can include one or more monitoring servers 440 that can: execute process 200 as described above in connection with FIG. 2; receive a request from a user device for an identity of a VPN server to establish a connection with; maintain information on workload information for various VPN servers; and/or perform any other suitable actions. Monitoring servers 440 can communication with VPN servers using communications links 412 over communications network 402 (e.g., if the VPN server is located remotely from monitoring server 440) and/or directly (e.g., if the VPN server is located locally and communications link 412 is a suitable direct link).

As shown in FIG. 4, user device 410-1, which can be executing process 100, is connected to communication network 402 by communications link 404-1 which includes a connection that is not a secure connection (e.g., as described above in connection with process 100 of FIG. 1). As described above in connection with 110 of FIG. 1, process 100 can initiate a virtual private network connection (such as VPN connection 414) to a VPN server (such as VPN server 420-1) in response to determining that the connection over communication link 404-1 is not secure. As described above, VPN connection 414 can be established with VPN server 420-1 rather than another VPN server (such as VPN server 420-2) for any suitable reason, such as the workload of VPN server 420-1 being reported by monitoring server 430 to be lower than the workload of VPN server 420-2. After establishing VPN connection 414, user device 410-1 can use VPN server 420-1 to request content from content server 430 via a proxy connection to content server 430.

As also shown in FIG. 4, user device 410-2, which can be executing process 100, is connected to communication network 402 by communications link 404-2 which includes a connection that is a secure connection (e.g., as described above in connection with process 100 of FIG. 1). As described above in connection with 108 of FIG. 1, process 100 can cause an indication to be presented to a user of user device 410-2 that the connection is secure, and the user device can communication using communications network 402 normally without process 100 initiating a virtual private network connection.

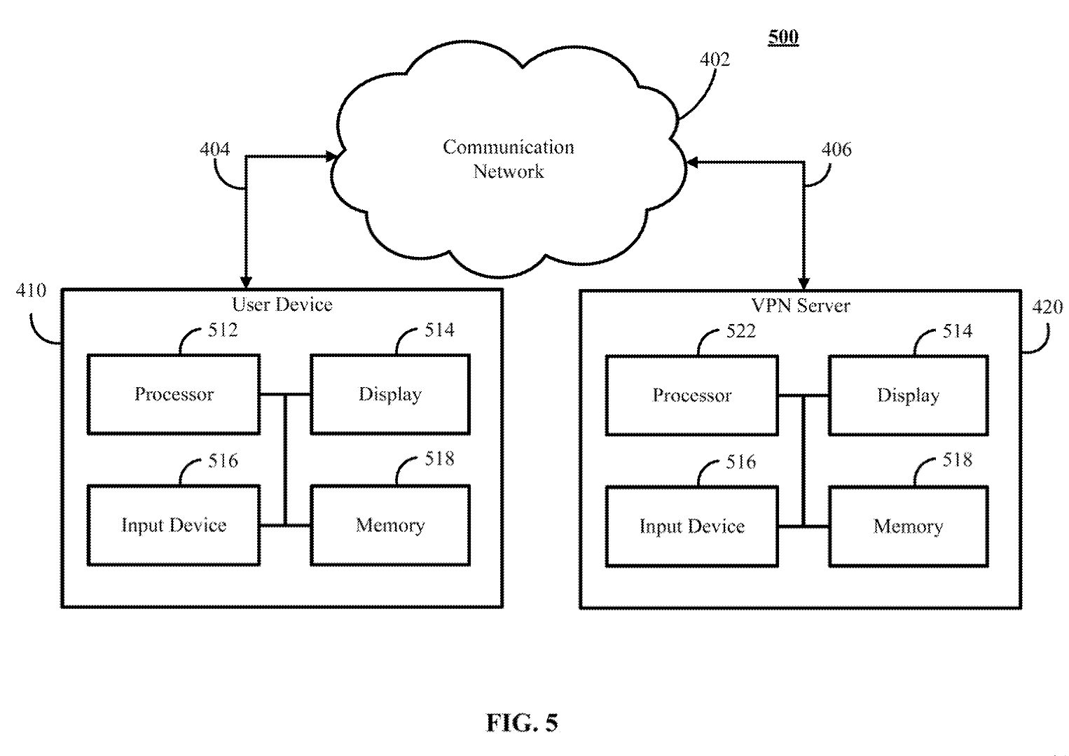

FIG. 5 illustrates an example 500 of hardware that can be used to implement one of user device 410 and server 420 depicted in FIG. 4 in accordance with some embodiments of the disclosed subject matter. Referring to FIG. 5, user device 410 can include a hardware processor 512, a display 514, an input device 516, and memory 518, which can be interconnected. In some embodiments, memory 518 can include a storage device (such as a non-transitory computer-readable medium) for storing a computer program for controlling hardware processor 512.

Hardware processor 512 can use the computer program to present on display 514 a user interface for presenting various visual information to a user, such as an indication of whether a current network is secure, as well as any other suitable visual information. It should be noted that data received through communications link 404 or any other communications links can be received from any suitable source such as VPN server 420, content server 430, and/or any other suitable source. In some embodiments, hardware processor 512 can send and receive data through communications link 404 or any other communication links using, for example, a transmitter, receiver, transmitter/receiver, transceiver, or any other suitable communication device, such as transmitter/receiver. Display 514 can include, a flat panel display, a touchscreen display, a projector, a cathode ray tube display, a video output port, a speaker(s), and/or any other suitable display and/or presentation devices. Input device 516 can include any suitable input device such as a computer keyboard, a computer mouse, a microphone, a touchpad, a voice recognition circuit, a touch interface of a touchscreen, and/or any other suitable input device.

VPN server 420 can include a hardware processor 522, a display 524, an input device 526, and memory 528, which can be interconnected. In some embodiments, memory 528 can include a storage device (such as a non-transitory computer-readable medium) for storing a server program for controlling hardware processor 522.

Hardware processor 522 can use the server program to communicate with user devices 410 to, for example, establish a VPN connection, receive request for data from a particular address, transmit data received from the address, and/or perform any other suitable functions. It should be noted that data received through communications link 406 or any other communications links can be received from any suitable source, such as user device 410, content server 430, monitoring server 440, and/or any other suitable device. In some embodiments, hardware processor 522 can send and receive data through communications link 406 or any other communication links using, for example, a transmitter, receiver, transmitter/receiver, transceiver, or any other suitable communication device. Display 524 can include a flat panel display, a touchscreen, a projector, a cathode ray tube display, a video output port, a speaker(s), and/or any other suitable display and/or presentation devices. Input device 526 can include a computer keyboard, a computer mouse, a microphone, a touchpad, a voice recognition circuit, a touch interface of a touchscreen, and/or any other suitable input device.

Content server 430 and/or monitoring server 440 can include components similar to those described in connection with VPN server 420 and/or user device 410.

In some embodiments, the mechanisms described herein can include server-side software, client-side software, server-side hardware, client-side hardware, firmware, or any suitable combination thereof. For example, these mechanisms can encompass one or more computer programs that cause a hardware processor to execute the mechanisms described herein (e.g., the hardware processor can be programmed to execute the mechanisms described herein). For instance, these mechanisms can encompass a computer program written in a programming language recognizable by user device 410, VPN server 420 and/or monitoring server 440 that is executing the mechanisms (e.g., a program written in a programming language, such as, Java, C, Objective-C, C++, C#, JavaScript, Visual Basic, HTML, XML, ColdFusion, any other suitable approaches, or any suitable combination thereof).

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

In some embodiments of the disclosed subject matter, the above described steps of the processes of FIGS. 1-3 can be executed or performed in any order or sequence not limited to the order and sequence shown and described in the figures. Also, some of the above steps of the processes of FIGS. 1-3 can be executed or performed substantially simultaneously where appropriate or in parallel to reduce latency and processing times. Furthermore, it should be noted that FIGS. 1-3 are provided as examples only. At least some of the steps shown in these figures may be performed in a different order than represented, performed concurrently, or omitted.

The provision of the examples described herein (as well as clauses phrased as “such as,” “e.g.,” “including,” and the like) should not be interpreted as limiting the claimed subject matter to the specific examples; rather, the examples are intended to illustrate only some of many possible aspects. It should also be noted that, as used herein, the term mechanism can encompass hardware, software, firmware, or any suitable combination thereof.

Accordingly, methods, systems, and media for secure connection management are provided.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method for secure connection management, the method comprising:
detecting, using a hardware processor, a new network connection;
determining that the new network connection is not a secure connection;
establishing a virtual private network connection in response to determining that the new network connection is not secure; and
upon establishing the virtual private network connection, indicating to a user that the virtual private connection is established.

2. The method of claim 1, wherein determining that the network connection is not a secure connection comprises determining that the network connection includes an unencrypted wireless network connection.

3. The method of claim 1, wherein establishing a virtual private network connection comprises:
determining a server to which the virtual private network connection is to be made;
initiating a virtual private network connection to the server;
causing a first colored indicator to be presented to the user in response to the initiating, wherein the first color indicates that a connection to the virtual private network connection is initiated; and
wherein indicating to a user that the virtual private connection is established comprises causing a second colored indicator to be presented to the user.

4. The method of claim 3, wherein determining the server comprises:
determining a location of a device including the hardware processor;
selecting a plurality of servers including the server based on the location of the device;
receiving information identifying one server of the plurality of servers as a server having a lowest workload; and
selecting the one server from a plurality of servers as the server to which the virtual private network connection is to be made.

5. The method of claim 3, further comprising:
determining that the new network connection is a secure connection; and
causing a third colored indicator to be presented to the user upon determining that the new network connection is a secure connection.

6. The method of claim 5, further comprising:
determining that the connection to the virtual private network cannot be established; and
causing a fourth colored indicator to be presented to the user upon determining that the virtual private network connection cannot be established, wherein the fourth color indicates that a connection to the virtual private network cannot be established.

7. The method of claim 5, wherein the first color is yellow, the second color is green, the third color is blue and the fourth color is red.

8. The method of claim 3, wherein the indicator is at least one of an icon displayed by a display coupled to the hardware processor, and an indicator light coupled to the hardware processor.

9. The method of claim 3, further comprising:
determining that the connection to the virtual private network cannot be established using a first port;
automatically choosing a second port of the server to use in establishing the virtual private network connection; and
initiating the virtual private network connection to the server using the second port.

10. A system for secure connection management, the system comprising:
a hardware processor programmed to:
detect a new network connection;
determine that the new network connection is not a secure connection;
establish a virtual private network connection in response to determining that the new network connection is not secure; and
upon establishing the virtual private network connection, indicate to a user that the virtual private connection is established.

11. The system of claim 10, wherein the hardware processor is further programmed to determine that the network connection includes an unencrypted wireless network connection.

12. The system of claim 10, wherein the hardware processor is further programmed to:
determine a server to which the virtual private network connection is to be made;
initiate a virtual private network connection to the server;
cause a first colored indicator to be presented to the user in response to the initiating, wherein the first color indicates that a connection to the virtual private network connection is initiated; and
cause a second colored indicator to be presented to the user upon connection to the virtual private network connection being successfully established.

13. The system of claim 12, wherein the hardware processor is further programmed to:
determine a location of a device including the hardware processor;
select a plurality of servers including the server based on the location of the device;
receive information identifying one server of the plurality of servers as a server having a lowest workload; and
select the one server from a plurality of servers as the server to which the virtual private network connection is to be made.

14. The system of claim 12, wherein the hardware processor is further programmed to:
determine that the new network connection is a secure connection; and
cause a third colored indicator to be presented to the user upon determining that the new network connection is a secure connection.

15. The system of claim 14, wherein the hardware processor is further programmed to:
determine that the connection to the virtual private network cannot be established; and
cause a fourth colored indicator to be presented to the user upon determining that the virtual private network connection cannot be established, wherein the fourth color indicates that a connection to the virtual private network cannot be established.

16. The system of claim 14, wherein the first color is yellow, the second color is green, the third color is blue and the fourth color is red.

17. The system of claim 12, wherein the indicator is at least one of an icon displayed by a display coupled to the hardware processor, and an indicator light coupled to the hardware processor.

18. The system of claim 12, wherein the hardware processor is further programmed to:
determine that the connection to the virtual private network cannot be established using a first port;
automatically choose a second port of the server to use in establishing the virtual private network connection; and
initiate the virtual private network connection to the server using the second port.

19. A non-transitory computer-readable medium containing computer executable instructions that, when executed by a processor, cause the processor to perform a method for secure connection management, the method comprising:
detecting a new network connection;
determining that the new network connection is not a secure connection;
establishing a virtual private network connection in response to determining that the new network connection is not secure; and
upon establishing the virtual private network connection, indicating to a user that the virtual private connection is established.

20. The non-transitory computer-readable medium of claim 19, wherein determining that the network connection is not a secure connection comprises determining that the network connection includes an unencrypted wireless network connection.

21. The non-transitory computer-readable medium of claim 19, wherein establishing a virtual private network connection comprises:
determining a server to which the virtual private network connection is to be made;
initiating a virtual private network connection to the server;
causing a first colored indicator to be presented to the user in response to the initiating, wherein the first color indicates that a connection to the virtual private network connection is initiated; and
wherein indicating to a user that the virtual private connection is established comprises causing a second colored indicator to be presented to the user.

22. The non-transitory computer-readable medium of claim 21, wherein determining the server comprises:
determining a location of a device including the hardware processor;
selecting a plurality of servers including the server based on the location of the device;
receiving information identifying one server of the plurality of servers as a server having a lowest workload;
selecting the one server from a plurality of servers as the server to which the virtual private network connection is to be made.

23. The non-transitory computer-readable medium of claim 21, wherein the method further comprises:
determining that the new network connection is a secure connection; and
causing a third colored indicator to be presented to the user upon determining that the new network connection is a secure connection.

24. The non-transitory computer-readable medium of claim 23, wherein the method further comprises:
determining that the connection to the virtual private network cannot be established; and
causing a fourth colored indicator to be presented to the user upon determining that the virtual private network connection cannot be established, wherein the fourth color indicates that a connection to the virtual private network cannot be established.

25. The non-transitory computer-readable medium of claim 23, wherein the first color is yellow, the second color is green, the third color is blue and the fourth color is red.

26. The non-transitory computer-readable medium of claim 21, wherein the indicator is at least one of an icon displayed by a display coupled to the hardware processor, and an indicator light coupled to the hardware processor.

27. The non-transitory computer-readable medium of claim 21, wherein the method further comprises:
determining that the connection to the virtual private network cannot be established using a first port;
automatically choosing a second port of the server to use in establishing the virtual private network connection; and
initiating the virtual private network connection to the server using the second port.
